(19) United States
(12) Patent Application Publication
(10) Pub. No.: US 2006/0176326 A1
(43) Pub. Date: Aug. 10, 2006

(54) Fluid injector devices and methods for utilizing the same

(75) Inventors: Chung-Cheng Chou, Lujhu Township (TW); Tsung-Ping Hsu, Jungli City (TW); Weng-Chen Liu, Yuanlin Township (TW); Cheng-Hung Yu, Fongyuan City (TW); Shang-Shi Wu, Chiai (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/054,671

(22) Filed: Feb. 9, 2005

(51) Int. Cl. B41J 29/38

(52) U.S. Cl. 347/9

(57) ABSTRACT

A fluid injector device with a plurality of heaters for bubble generation is provided. The resistance of each heater is measured and compared with a standard operating resistance. Output signal is adjusted to heaters with resistance exceeding the standard operating resistance.

### BACKGROUND

The invention relates to fluid injection, and more particularly, to fluid injector devices and methods for improving injection performance by adjusting output parameters according to resistance of each heater of the fluid injector devices.

Typically, fluid injectors are employed in inkjet printers, fuel injectors, biomedical chips and other devices. Among inkjet printers presently known and used, injection by thermally driven bubbles has been most successful due to reliability, simplicity and relatively low cost.

FIG. 1 is a cross section of a conventional monolithic fluid injector 1 disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to inject the fluid 26 from the chamber 14.

The conventional monolithic fluid injector 1 using bubbles as a virtual valve is advantageous due to reliability, high performance, high nozzle density and low heat loss. As inkjet chambers are integrated in a monolithic silicon wafer and arranged in a tight array to provide high device spatial resolution, no additional nozzle plate is needed.

Heaters for conventional monolithic fluid injector 1, however, are critical for fluid injection. The resistive layer formed during front-end processes may cause uniform resistance distribution and variation of each heater across different regions of the monolithic silicon wafer. Resistance in some heaters may even exceed limitation such that injection quality is affected leading to overshooting and/or satellite droplets.

FIG. 2 is a block diagram of methods for optimizing printing parameters for a conventional inkjet printhead. After a controller receives and processes printing data, operating signals are transmitted to a printhead driver circuit for the fluid injector device. A voltage control power supply provides a control voltage V_{S} to the printhead driver circuit. The magnitude of the control voltage V_{S} is controlled by the voltage control power supply. The printhead driver circuit controlled by the controller provides a driving voltage pulse V_{P} to heaters of the thermal driven inkjet printhead, thereby trigging inkjet injection. U.S. Pat. No. 5,526,027, the entirety of which is hereby incorporated by reference, discloses an inkjet printer using a temperature sensor to provide resistance reference to each heater of the injector, thereby optimizing printing performance.

U.S. Pat. No. 6,244,682, the entirety of which is hereby incorporated by reference, discloses a method and apparatus using an optical scanning device to analyze a graph printed by an inkjet printer. By comparing printing results with the predetermined standard driving parameters, subsequent operating printing parameters are calibrated and optimized.

The aforementioned methods are applied to inkjet printers in which the resistances of each heater are within a specific range. If the resistance of each heater deviates from standard operating settings due to front-end process variation, deterioration of printing performance occurs and calibration may be required.

### SUMMARY

Fluid injector devices and methods for utilizing the same are provided to improve printing performance by measuring resistance of each heater of fluid injectors and comparing with standard operating resistance as reference for adjusting output operating parameters.

Embodiments of the invention provide a method for inkjet injection, comprising providing a fluid injector device with a plurality of heaters for bubble generation, measuring resistance of each heater, comparing the resistance of each heater with a standard operating resistance, and adjusting output signals to heaters with resistance exceeding the standard operating resistance.

Embodiments of the invention also provide a method for inkjet injection, comprising providing a fluid injector with a plurality of heaters for bubble generation, measuring resistance of each heater, comparing the resistance of each heater with a standard operating resistance, and adjusting output signals to heaters with resistance exceeding the standard operating resistance, while maintaining, standard output signal to heaters having the standard operating resistance.

Embodiments of the invention also provide a fluid injector device, comprising a plurality of heaters for bubble generation, a sensor connecting each heater for measuring resistance of heaters, a comparator comparing resistance of each heater with a standard operating resistance, and a controller adjusting output signal to heaters with resistance exceeding the standard operating resistance.

### DESCRIPTION OF THE DRAWINGS

The invention can be more fully understood by reading the subsequent detailed description in conjunction with the examples and references made to the accompanying drawings, wherein:

FIG. 1 is a cross section of a conventional monolithic fluid injector;

FIG. 2 is a block diagram of a conventional fluid injector device;

FIG. 3 is a block diagram of a fluid injector device according to embodiments of the invention;

FIG. 4 is a block diagram of a fluid injector device according to an exemplary embodiment of the invention;

FIG. 5 is a block diagram of a fluid injector device according to another exemplary embodiment of the invention; and

FIG. 6 is a block diagram of a fluid injector device according to embodiments of the invention.

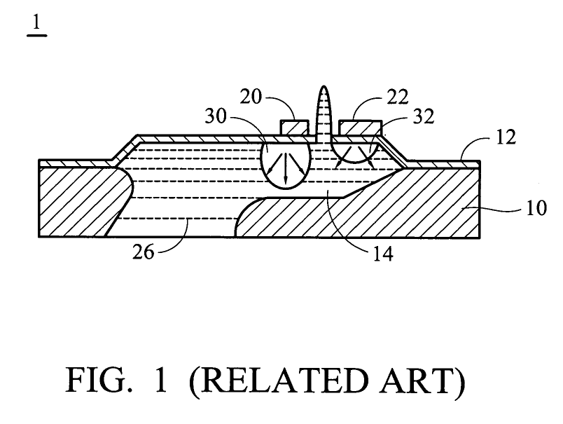

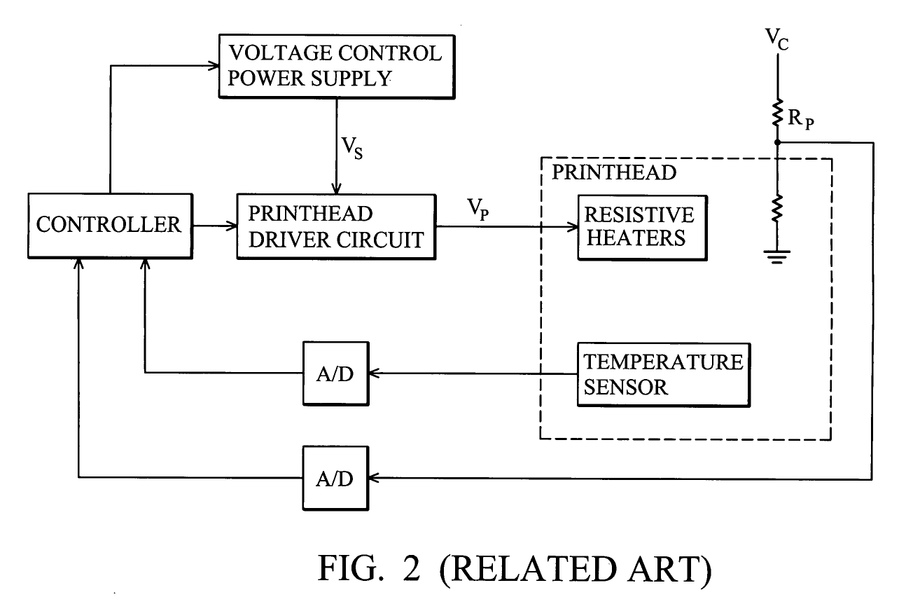

### DETAILED DESCRIPTION

Generally, resistances of heaters of thermally driven inkjet injectors dramatically affect the results of fluid injection. According to embodiments of the invention, each fluid injector comprises approximately 100-200 sets of bubble generators such as resistive heaters. In one exemplary embodiment, fluid injectors S1-S5 comprise heaters with resistance within a standard range of about 60-65 Ohm. When each heater of the fluid injectors S1-S5 is biased at 12V, the equivalent resistance of the entire interconnect of the fluid injector is about 10 Ohm with current through each heater about 160-170 mA. Thus, by heating 1.2 μs as well as selecting appropriate dimensional design of orifices, e.g., diameter of 16-18 μm, the volume of each injection droplet is within a desired range of about 5-6 pl. The density of the fluid is assumed to be equal to that of water with surface tension in a range of about 26-30 dyne/cm and viscosity in a range of about 1-2 cp.

Fluid injectors S6-S12 comprise heaters with resistance exceeding the standard range, such as about 60-95 Ohm. Heaters with resistance exceeding 65 Ohm are about 5%-22% of the total, and with resistance 100%-160% of the standard range of about 60-65 Ohm. According to an embodiment of the invention, fluid injectors S1-12 all function under the same driving parameters such as at 12V and 1.2 μs, whereby equivalent resistance of the entire interconnection is about 10 Ohm and current through each heater is about 160-170 mA. The results of each set of injectors are shown in table 1, where droplets with 95% standard volume (i.e., 5-6 pl) are indicated by “◯”, droplets with 90%-94% standard volume are indicated by “Δ”, droplets with 80%-89% standard volume are indicated by “⋆” and droplets with 80%-84% standard volume are indicated by “⋆⋆”.

TABLE 1

| group | results | heating time(μsec) | volume of droplet |
|---|---|---|---|
| S1 | normal | 1.2 | ◯ |
| S2 | normal | 1.2 | ◯ |
| S3 | normal | 1.2 | ◯ |
| S4 | normal | 1.2 | ◯ |
| S5 | normal | 1.2 | ◯ |
| S6 | high | 1.2 | Δ |
| S7 | high | 1.2 | Δ |
| S8 | high | 1.2 | ⋆ |
| S9 | high | 1.2 | ⋆⋆ |
| S10 | high | 1.2 | ⋆⋆ |
| S11 | high | 1.2 | ⋆⋆ |
| S12 | high | 1.2 | ⋆ |

According to Table 1, the difference between resistances of each heater can thus be determined, with corresponding effects on injecting quality.

Table 2 shows results on printing of adjusting driving parameters according to resistance of each set of fluid injectors S6-S12. For example, the driving parameters can be adjusted by increasing heating time. By incrementally adding 0.2 μs each injection, printing quality is improved. Although the present disclosure provides a method for improving print performance by incrementally increasing heating time, it should be noted that other parameters such as operating voltage or driving current may also be adjusted within the scope of embodiments of the invention. For example, increasing 100-120% of the standard operating voltage of about 12V may also improve droplet injecting performance.

TABLE 2

| heating time(μsec) | S6 | S7 | S8 | S9 | S10 | S11 | S12 |
|---|---|---|---|---|---|---|---|
| 1.2 | Δ | Δ | ⋆ | ⋆⋆ | ⋆⋆ | ⋆⋆ | ⋆ |
| 1.4 | ◯ | Δ | ◯ | Δ | Δ | Δ | Δ |
| 1.6 | ◯ | ◯ | ◯ | ◯ | ◯ | Δ | Δ |
| 1.8 | ◯ | ◯ | ◯ | ◯ | ◯ | ◯ | ◯ |

Although by increasing heating time of each set of fluid injectors can improve injection performance, it is critical for the increase to be incremental since overheating can affect operating frequency of the injectors as well as lifetime thereof. Heater overheating can cause overshoot and/or satellite droplets. Table 3 shows the relationship between injectors with normal resistance and injection performance with different heating time. Injector S5 may overshoot at heating time of 2 μs, as shown in Table 3.

TABLE 3

| heating time(μsec) | S1 | S2 | S3 | S4 | S5 |
|---|---|---|---|---|---|
| 1.2 | ◯ | ◯ | ◯ | ◯ | ◯ |
| 1.4 | ◯ | ◯ | ◯ | ◯ | ◯ |
| 1.6 | ◯ | ◯ | ◯ | ◯ | ◯ |
| 1.8 | ◯ | ◯ | ◯ | ◯ | ◯ |
| 2.0 | ◯ | ◯ | ◯ | ◯ | Δ |

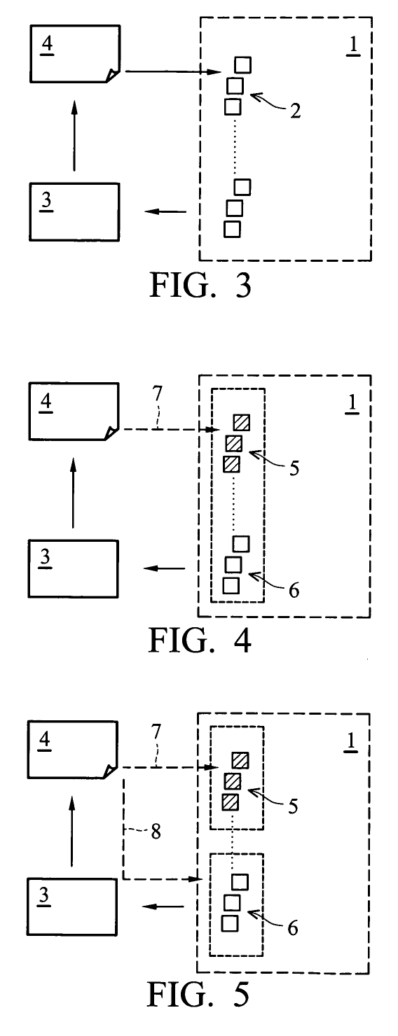

FIG. 3 is a block diagram of embodiments of the invention. When driving an injector 1, resistance of each heater 2 is measured by a resistance sensor 3. If the resistance of each heater 2 is within a standard range, such as about 60-65 Ohm, the injector 1 is driven by predetermined parameters. If the resistance is higher than the standard range, controller 4 adjusts the driving signal by increasing heating time, thereby improving injection performance.

FIG. 4 is a block diagram of a fluid injector according an exemplary embodiment of the invention. According to the aforementioned test results, in the exemplary embodiment, resistance of each heater of the fluid injectors is measured before injection. If resistance of all heaters is within the standard range, the injector is triggered by predetermined driving parameters. If some resistance of heaters exceeds the normal range, the driving parameters of each heater are adjusted to improve printing performance. Referring to FIG. 4, after testing resistance of each heater, normal heaters 5 and, abnormal heaters 6 are segregated according to test results. The driving conditions for all heaters are adjusted to implement improved injection performance.

FIG. 5 is a block diagram of another fluid injector according to another exemplary embodiment of the invention. According to the aforementioned test results, in the illustrated embodiment, resistance of each heater of the fluid injectors is measured before injection. If resistance of all heaters is within the standard range, the injector is triggered using predetermined driving parameters. If some resistance of heaters exceeds the standard range, the driving parameters of each heater are adjusted to implement optimizing injection performance. Referring to FIG. 5, after testing resistances of each heater, normal heater 5 and abnormal heater 6 are segregated according to test results. The driving conditions for each abnormal heater are adjusted, while those of the normal heater maintain predetermined condition.

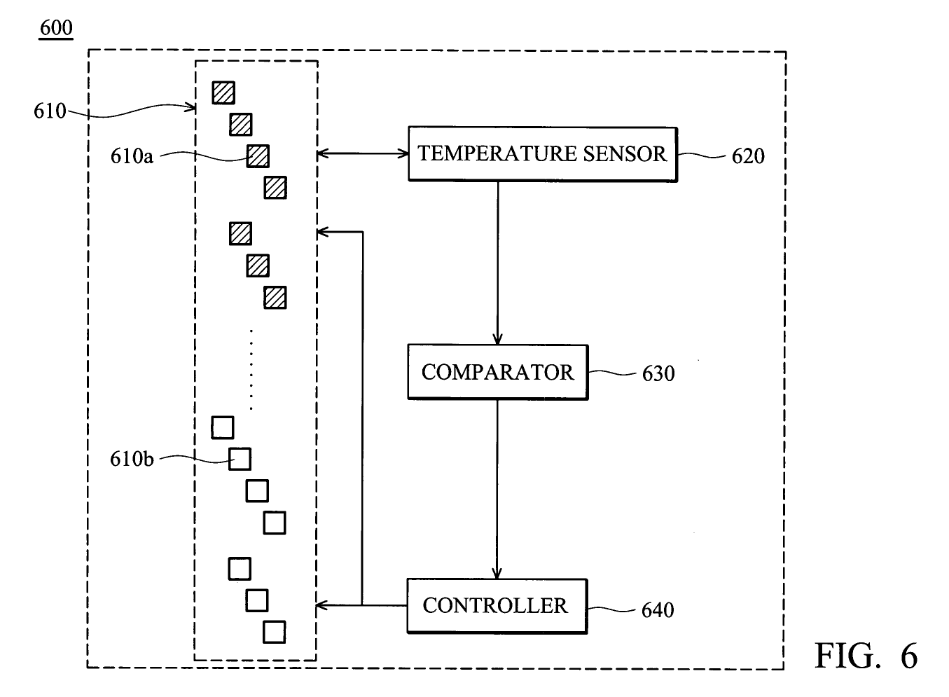

FIG. 6 is a block diagram of a fluid injector device 600 according to embodiments of the invention. The fluid injector device 600 comprises a plurality of heaters 610 for bubble generation, a sensor 620 connecting each heater for measuring resistance of heater, a comparator 630 comparing the resistance of each heater with the standard operating resistance, and a controller 640 adjusting output signals driving fluid injector to heaters with resistance exceeding the standard operating resistance. In one embodiment, the controller 640 adjusts output parameters for all driving fluid injectors 610. Alternatively, the controller 640 may also adjust output parameters for driving fluid injector 610b in which resistance of each heater with resistance exceeding the standard operating resistance, while maintaining standard operating parameters for injectors 610a equal to the standard operating resistance.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for inkjet injection, comprising:
providing a fluid injector device with a plurality of heaters for bubble generation;
measuring resistance of each heater;
comparing the resistance of each heater with a standard operating resistance; and
adjusting output signals to heaters with resistance exceeding the standard operating resistance.

2. The method as claimed in claim 1, wherein the standard operating resistance is in a range of about 60-65 Ohm.

3. The method as claimed in claim 1, wherein output signals to heaters is adjusted when resistance of heaters exceeds about 100-160% of about 60-65 Ohm of the standard range.

4. The method as claimed in claim 1, wherein output signals to heaters adjust heating time or driving voltage to heaters.

5. The method as claimed in claim 4, wherein heating time is increased to about 100-150% of standard operating heating time.

6. The method as claimed in claim 5, wherein the standard operating heating time is about 1.2 μsec.

7. The method as claimed in claim 6, wherein driving voltage is increased to about 100-120% of standard operating driving voltage.

8. The method as claimed in claim 7, wherein the standard operating driving voltage is about 12V.

9. A method for inkjet injection, comprising:
providing a fluid injector with a plurality of heaters for bubble generation;
measuring resistance of each heater;
comparing the resistance of each heater with a standard operating resistance; and
adjusting output signal to heaters with resistance higher than the standard operating resistance, while maintaining standard output signal to heaters having the standard operating resistance.

10. The method as claimed in claim 9, wherein the standard operating resistance is about 60-65 Ohm.

11. The method as claimed in claim 9, wherein output signal to heaters is adjusted when resistance of heaters exceeds about 100-160% of about 60-65 Ohm of the standard operating resistance.

12. The method as claimed in claim 9, wherein output signal to heaters adjusts heating time or driving voltage to heaters.

13. The method as claimed in claim 12, wherein heating time is increased to about 100-150% of standard operating heating time.

14. The method as claimed in claim 13, wherein the standard operating heating time is about 1.2 μsec.

15. The method as claimed in claim 14, wherein driving voltage is increased to about 100-120% of standard operating driving voltage.

16. The method as claimed in claim 15, wherein the standard operating driving voltage is about 12V.

17. A fluid injector device, comprising:
a plurality of heaters for bubble generation;
a sensor connecting each heater for measuring resistance of heaters;
a comparator comparing resistance of each heater with a standard operating resistance; and
a controller adjusting output signal to heaters with resistance exceeding the standard operating resistance.

18. The device as claimed in claim 17, wherein the sensor measures resistance of each heater by applying a current through each heater.

19. The device as claimed in claim 17, wherein the controller adjusts output signal to heaters with resistance exceeding the standard operating resistance, while maintaining standard output signal to heaters having the standard operating resistance.
